(19) United States
(12) Patent Application Publication
(10) Pub. No.: US 2024/0202036 A1
(43) Pub. Date: Jun. 20, 2024

(54) UNLOADING INTERDEPENDENT SHARED LIBRARIES

(71) Applicant: International Business Machines Corporation, Armonk, NY (US)

(72) Inventors: Heng WANG, Beijing (CN); Xiao Ling CHEN, Beijing (CN); Yan HUANG, Beijing (CN); Xin Peng LIU, Beijing (CN); Zi Yun KANG, Handan (CN)

(21) Appl. No.: 18/066,837

(22) Filed: Dec. 15, 2022

(51) Int. Cl. G06F 9/50

(52) U.S. Cl. CPC G06F 9/5033

(57) ABSTRACT

Unloading shared resources is described. A shared library correlation table (SLCT) is generated in a mock resource. During a close function, selecting an entry in the SLCT is selected for reducing a reference count of the selected entry in the SLCT, a status of the selected entry based on the reference count is verified, and an associated container of the selected entry is removed from memory when the status of the selected entry indicates the associated container is not a shared resource, thereby avoiding segmentation faults.

### BACKGROUND

The present invention relates generally to accessing, utilizing, and unloading various computer program resources (e.g., a resource, a library, a binary, a function, etc.). More specifically, the present invention relates to utilizing a shared library correlation table in a containerized environment to cleanly unload runtime resources when unloading an interdependent shared library, thereby avoiding segmentation errors.

Many types of computer programs and programming languages include an option for dynamic loading (DL), which is a mechanism that allows a computer program to load a library (or other similar resource) into memory, retrieve the addresses of associated functions and variables (i.e. objects) contained in the library, execute those functions or access those variables, and unload the library from memory. In some examples, these libraries or resources may include a shared object, where the shared object is called by another library or resource during runtime. Fetching, extracting, and loading these shared object resources can cause a segmentation fault during runtime when the resources are released or closed out of order. Providing a mechanism to allow for DL of these shared objects, without causing segmentation faults remains a challenge.

### SUMMARY

### Brief Description of the Drawings

FIG. 1 depicts a block diagram illustrating a system, according to one embodiment.

FIG. 2 depicts a system flow block diagram illustrating a system with a shared library correlation table, according to one embodiment.

FIG. 3 depicts a system flow block diagram for a call function using the shared library correlation table, according to one embodiment.

FIG. 4 depicts a system flow block diagram for a close function using the shared library correlation table, according to one embodiment.

FIGS. 5A and 5B are methods for a shared library correlation table, according to one embodiment.

FIG. 6 depicts details of computing environment, according to one embodiment.

### DETAILED DESCRIPTION

As described above, computer programs may utilize various resources during runtime or execution. These resources may also be referred to a microservices. Microservices are a type of software architecture where the functionality of a software application is broken up into smaller fragments to make the application more resilient and scalable. The smaller fragments are referred to as “services.” Each service is modularized in that it focuses only on a single functionality of the application and is isolated from the others, making each one of them independent. Modularity allows development teams to work separately on the different services without requiring more complex design-related orchestration between the teams.

The different microservices can communicate with each other through APIs or web services to execute the overall functionality of the application. For example, microservices can communicate with one another and with other software applications using a remote procedure call (RPC) protocol or other communication mechanisms. RPC is a protocol that one program may utilize to request a service from a program located in another computer on a network without having to understand the network's details. In some examples, RPC protocols use the client-server model, where the requesting program is a client, and the service-providing program is the server.

In some examples, application programs utilize compilations of resources or libraries, accessed via RPC, to improve efficiency in both the development and execution of the application program. In the embodiments described herein, a library is a collection of non-volatile resources used by computer programs. In some examples, libraries may include configuration data, documentation, help data, message templates, pre-written code, pre-written subroutines, and other similar resources for use in program development and execution. For example, programmers who writing a higher-level computer program can use a library to make system calls in a program instead of implementing those system calls over and over again during program development.

While code that is part of a program under development is generally organized to be used only within that one program, library code is organized such that it may be utilized by multiple programs that have no connection to each other. For example, a library may be organized for the purposes of being reused by independent programs or sub-programs, where a user only needs to how to access or call an external interface of the library program and not the internal details of the library. This allows for easy reuse of standardized program elements within the library. For example, when a program under development invokes a library, it gains the behavior implemented inside that library without having to implement that behavior itself. Each of the aspects described provide for libraries that encourage the sharing of code in a modular fashion and ease the distribution of the code.

As described above, DL is a mechanism by which a computer program can, at run time, load a library (or other binary/resource) into memory using RPC; retrieve the addresses of functions and variables contained in the library; execute those functions or access those variables; and unload the library from memory. Many modern open source high performance RPC frameworks exist that can run in any computing environment (e.g., can run on any type of hardware or software platform). However, RPC frameworks often do not support a cross-process invoke, and, accordingly, a corresponding library is not able to be unloaded when invoked or called by several different programs. This inability to unload the resource can cause a segmentation fault resulting in errors in the functions of the program and general computing environment.

Various developments have addressed part of the segmentation fault issues in DL. Some computer systems, computer-implemented methods, and computer program products avoid the segmentation faults that occur when known RPC frameworks attempt to unload a shared library by utilizing containers to clean runtime resources when unloading the shared library. The containers provide for unloading the shared library and cleaning up the running environment safely. However, multiple dependent or interdependent libraries still present a problem during library unloading processes when a dependent library is still invoked during an unloading of an invoked library.

The systems and methods herein provide for improved resource unloading in a containerized environment with multiple dependent or interdependent resources. The systems and methods provide additional avoidance of segmentation faults that may occur when multiple dependent or interdependent resources/libraries are loaded/unloaded into a memory or container by utilizing a shared library correlation table (SLCT) to track a status of an invoked or loaded resource.

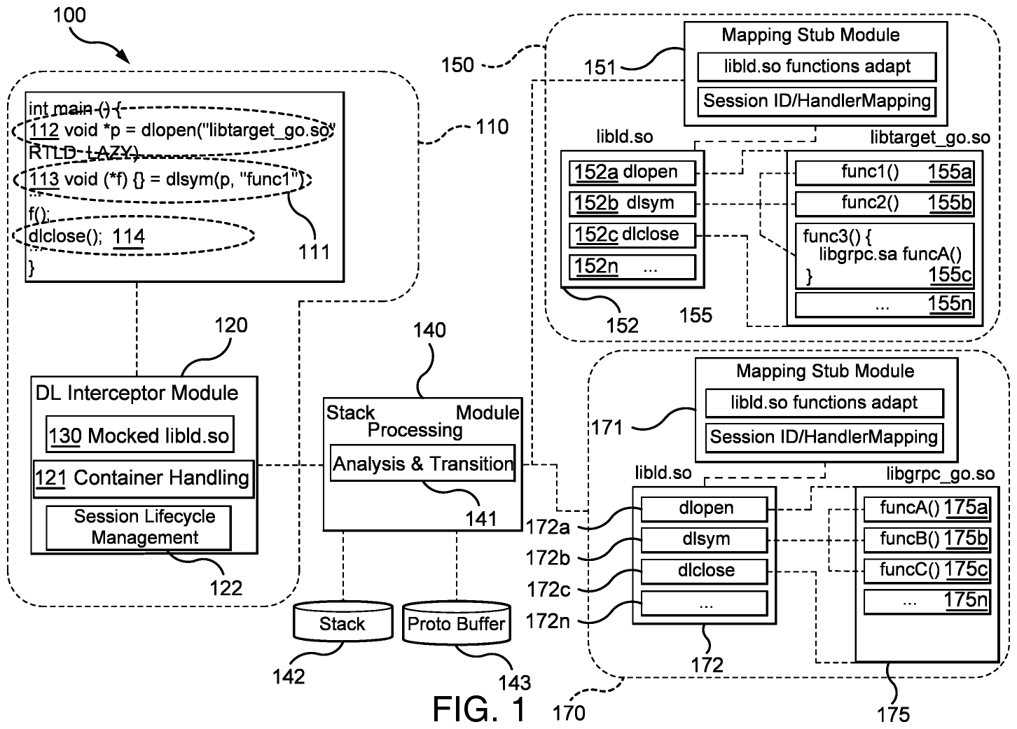

FIG. 1 depicts a block diagram illustrating a system 100, according to one embodiment. For ease of illustration and discussion, the embodiments and examples described herein will be described in relation to standard open source computer programs and languages; however, it should be understood that the systems and methods may be utilized in any appropriate computer program. For example, open source programs “libld.so” and “ld-linux.so” are standard programs that may be implemented or written into a computer program. In some examples, the libld.so program finds and loads shared objects (shared libraries) needed by a program, prepares the loaded object to run, and executes the loaded object. Accordingly, the program libld.so is a dynamic linker/loader which provides DL as described above. In some examples, libld.so includes various embedded functions including dlopen( )/dlsym( )/dlcose( ) which load, call, and unload other shared libraries as described in more detail herein.

For purposes of illustration, various embodiments described herein use a containerized libld.so (i.e., a containerized dynamic linker/loader) and a target shared library (i.e., the shared library to be loaded/unloaded). In the examples herein, a shared library/resource has a suffix “.so”. For example, the program instruction/function “libtarget_go.so,” “libgrpc.so,” and “libld.so” are shared libraries (these are example names and the shared library may take any name). However, “libld.so” is a special shared library in that “libld.so” (or ld.so) is a dynamic linker/loader that provides dlopen( )/dlsym( )/dlcose( ) to load/unload other shared libraries within container environments as discussed herein.

Referring back to FIG. 1, the system 100 includes a host 110 in communication with containerization platforms 150 and 170 through a stack processing module 140. The host 110 includes a set of software instructions (or computer code) 111 and a DL interceptor module 120. The computer code 111 includes a plurality of instructions including an open instruction 112 which includes a dlopen( ) command to load a resource, a function instruction 113, which includes a dlsym( ) command to extract contents from a resource, and a close instruction 114, which includes a dlcose( ) command to unload the resource. In some examples, the computer code 111 is a program/application, which loads a shared library such as “libtarget_go.so” or resource 155. The program instructions dlopen( )/dlsym( )/dlclose( ) in the computer code 111 are three functions that are provided by libld.so 152 to load shared libraries, such as resource 155. The computer code 111 demonstrates the process to load/unload the shared library libtarget_go.so by utilizing mocked dlopen( )/dlsym( )/dlclose( ) which are provided by mocked dynamic linker/loader (i.e., libld.so) in the DL interceptor module 120.

In some examples, the DL interceptor module 120 manages container lifecycles for containerized shared libraries. The DL interceptor module 120 includes session lifecycle management module 122 and container handling module 121. The container handling module 121 creates/destroys containers such as (containerization platforms 150 and 170), as well as delivers data and function requests from the host 110 to a container. The session lifecycle management module 122 manages a session lifecycle, which includes creating/destroying a session for a container, where the session and its related data (e.g., session ID) is used to communicate with a container when a DL function is received.

The system 100 also includes stack processing module 140 which converts between a stack and a protocol buffer 143. In some examples, protocol buffers are a language-neutral, platform-neutral, extensible mechanism for serializing structured data. A user of the system 100 may define how the data will be structured once using the stack processing module 140, then generated source code is used to easily write and read the structured data to and from a variety of data streams using a variety of programming languages. The system 100 also includes containerization platform 150 and containerization platform 170 which are initiated by the DL interceptor module 120. Each of the containerization platform 150 and containerization platform 170 include associated mapping stub modules 151 and 171 discussed in more detail herein.

In some examples, the DL interceptor module 120 and the mapping stub modules 151 and 171 communicate with each other via the stack processing module 140 which converts and deliver data to the various modules. In some examples, the Mapping Stub modules 151 and 171 load the target shared library to the memory address space by utilizing libdl.so 152 and 172 in the respective containers. The mapping stub modules 151 and 171 record a map between a session ID for the respective container and a data handler. Data is thus routed to a target library when a DL function received at the DL interceptor module 120. Additionally, when a dlclose( ) request is received at the DL interceptor module 120, the DL interceptor module 120 destroys an associated container and invalidates the session ID.

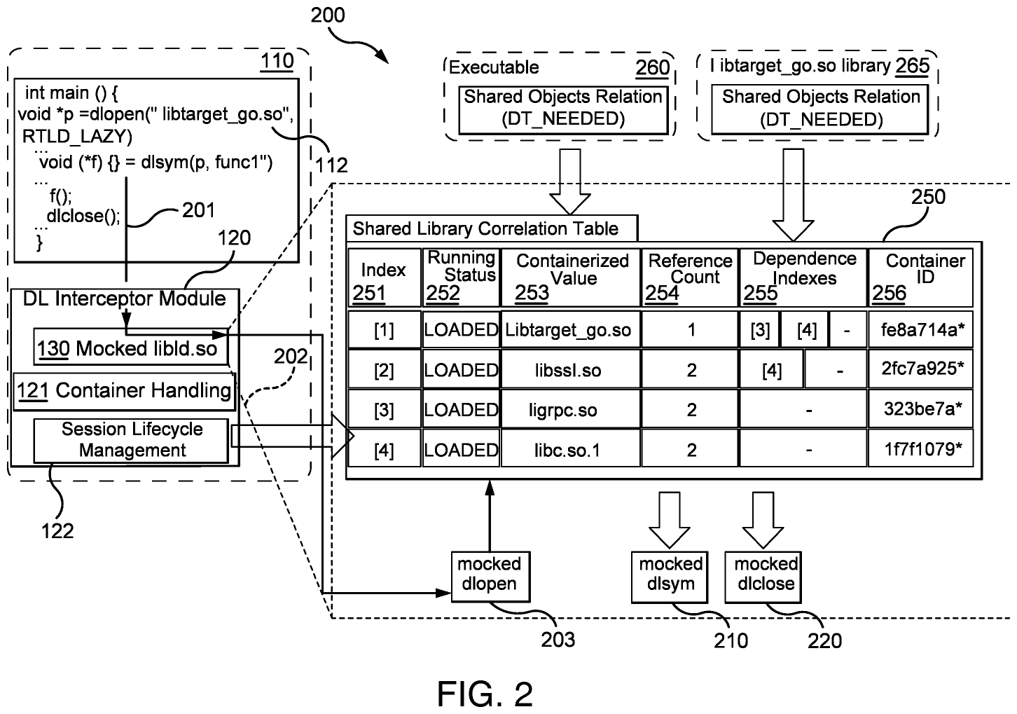

In some examples, such as when a SLCT is not utilized, the computer code 111 calls or invokes “libld.so”. However, “libld.so” is not able to clean up the whole environment when unloading dependent libraries called during the various function calls of the libld.so. For example, libld.so 152 may cause errors, such as segmentation fault errors, during unloading which impacts the computer code 111 if an invoked dependent library is still loaded. In order to prevent these errors, the DL interceptor module 120 includes a Mocked libld.so 130 with a SLCT described in greater detail in relation to FIGS. 2-5. In some examples, the computer code 111 is intercepted by the Mocked libld.so 130 instead of a real libld.so in order to provide an SLCT and prevent segmentation faults as described herein.

In some examples, the DL interceptor module 120 is configured to manage container lifecycles, and also deliver data and function requests from the computer code 111 to the containerization platforms 150 and 170. The DL interceptor module 120 also manages a session lifecycle. For example, the DL interceptor module 120 unloads a shared library by destroying the container which has the shared library inside. Accordingly, any unexpected error inside a container will not impact the application/program which locates at the host.

The Mocked libld.so 130 receives the requests from the computer code 111, and the requests will be handled and delivered to the real “libld.so” (e.g., libld.so 152) upon creation of a respective container environment by the DL interceptor module 120. For example, the DL interceptor module 120 also includes a session lifecycle management module 122 and a 121, configured and arranged as shown. The Session Lifecycle Management module 122 creates a session structure for which one program/application corresponds to a unique session structure. The session structure includes a “session ID”, which is a “targeted shared library name”. When the customized container starts up, the “targeted shared library name” is loaded by the dynamic linker/loader (libld.so) inside the container.

For the container handling module 121, DL means “dynamic link,” and the “dynamic link library” has the same meaning as a “shared library.” Thus, “DL Name” is the dynamic link library name, which is the shared library name. Thus, the container handling module 121 provides functions to manage containers. For example, the container handling module 121 provides Init( ) and Destroy( ) functions. Init (Session ID, DL Name) creates a container and passes the DL Name (the shared library name) to the container so that the dynamic linker/loader (libld.so) knows which shared library needs to be loaded inside the container. Destroy ( ) destroys the created container.

As discussed above, the containers and the DL interceptor module 120 communicate via the stack processing module 140. The stack processing module 140 includes an analysis and transition module 141, and the stack processing module 140 is communicatively coupled to a call stack 142 and a protocol buffer 143. In general, a call stack is a stack data structure that stores information about the active subroutines of a computer program. Although maintenance of the call stack is important for the proper functioning of most software, the details are normally hidden and automatic in high-level programming languages. Many computer instruction sets provide special instructions for manipulating stacks. A call stack is used for several related purposes, but the main reason for having one is to keep track of the point to which each active subroutine should return control when it finishes executing. An active subroutine is one that has been called, but is yet to complete execution, after which control should be handed back to the point of call. Such activations of subroutines may be nested to any level (recursive as a special case).

In some examples, the analysis and transition module 141 of the stack processing module 140 takes on performance of the main work of the stack processing module 140. For example, the parameters of computer code in a “stack” form are hard to transfer, but the parameters in a protocol buffer form are easy to transfer. In some examples, the analysis and transition module 141 provides two (2) parameters operations methods, namely Pack( ) and UnPack( ) to do the conversion. The stack processing module 140 reads the parameters from the call stack 142 of the running computer code, then converts the parameters to the protocol buffer form (i.e. protocol buffer 143). The stack processing module 140 may also convert the parameters from the protocol buffer form, then write the parameters back to the call stack 142 of the computer code. As noted, through the analysis and transition module 141, the stack processing module 140 provides two (2) parameter operations methods, namely Pack( ) and UnPack( ). The Pack( ) method reads the parameters from the call stack 142 of the running computer code, then converts the parameters to the protocol buffer form (i.e. protocol buffer 143). The UnPack( ) method converts the parameters from the protocol buffer form, then writes the parameters to the call stack 142 of the computer code.

The containerization platforms 150 and 170, include the mapping stub modules 151 and 171, a libld.so set of commands/functions (libld.so 152 and libld.so 172), and a libtarget_go.so set of commands/functions (commands 152a-n and 172a-n). In general, containerization platforms 150 and 170 may be an open source containerized platform configured and arranged for building, deploying, and managing containerized applications. An open source containerization platform enables developers to package applications into containers—standardized executable components combining application source code with the operating system (OS) libraries and dependencies required to run that code in any environment.

In some examples, containers and containerization platforms simplify delivery of distributed applications, and have become increasingly popular as organizations shift to cloud-native development and hybrid multi-cloud environments. Open source containerized platforms function as toolkits that enable developers to build, deploy, run, update, and stop containers using simple commands and work-saving automation through a single API. Containers are made possible by process isolation and virtualization capabilities built into the Linux kernel. These capabilities—such as control groups (Cgroups) for allocating resources among processes, and namespaces for restricting a processes access or visibility into other resources or areas of the system—enable multiple application components to share the resources of a single instance of the host operating system.

Referring more specifically to the containerization platforms 150 and 170, the containerization platform 150 is a container that contains the mapping stub module 151, dynamic linker/loader 152 (i.e., libdl.so), and other shared or target libraries, like libtarget_go.so, resource 155. When close instruction 114 is invoked by the computer code 111, the system 100 utilizes the DL interceptor module 120 to destroy the whole containerization platform 150. Accordingly, all the functions inside the container will be destroyed. Any failures (for example, a segmentation fault) that occur inside the container will not impact the language environment of the system 100. However, if a function, such as function 155c in the resource 155 has called a shared resource, such as function 175a in the resource 175, a segmentation fault may occur if the associated memory space has not been released (e.g., the container 170 has not been destroyed).

In some examples, the mapping stub module 151 loads the real libld.so, i.e., dynamic linker/loader 152 to the memory address space of containerization platform 150. The mapping stub module 171 loads the real libld.so, i.e., resource 172 to the memory address space of containerization platform 170. The libld.so 152 loads the libtarget_go.so to the memory address space of containerization platform 150. Then the map between the session ID and the handler is recorded by the mapping stub module 151. The data and dlsym( ) request are routed to the target library when a DL function comes in. The “libld.so function adapt” module receives the protocol buffer data from the host. The mapping stub module 151 keeps the map of a Session ID and Handler so that when a dlsym( ) request comes in, the mapping stub module” 151 knows the target place to which it should be routed.

The “libtarget.go.so” is a shared library which contains several of functions such as functions 155a-155n (e.g. “func1( )”, “func2 ( )”, and “func3 ( )”). However, the function 155c includes a call to another function in a different/dependent library, function 175a which requires the SLCT described in more detail herein in relation to FIGS. 2-5.

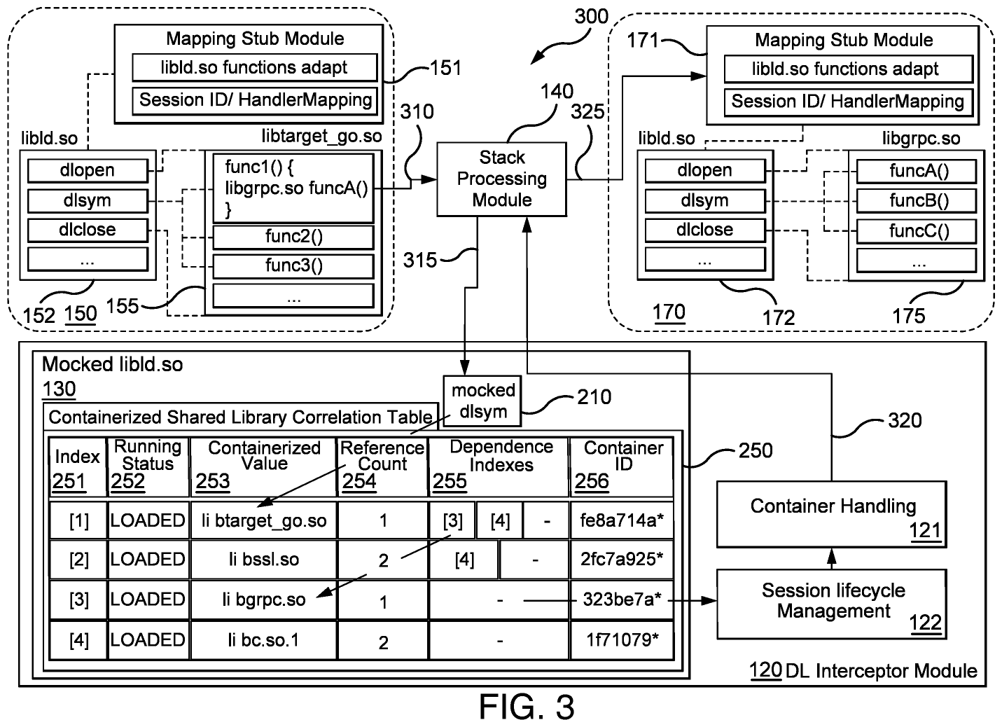

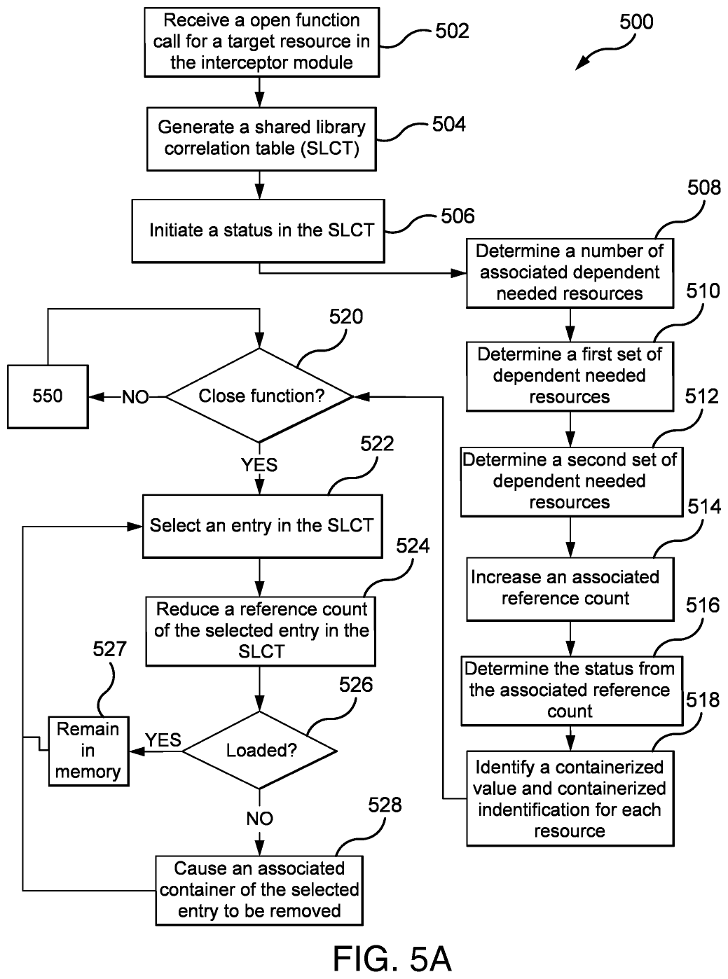

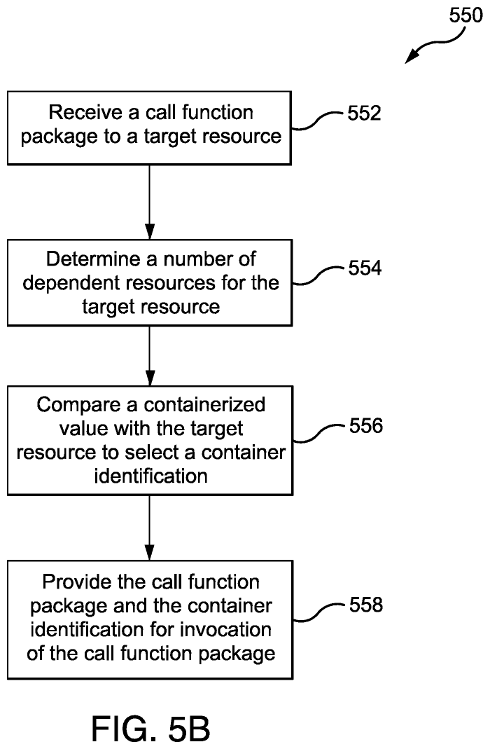

The operation of the system 100 is depicted in FIGS. 2, 3, and 4 and will be described with reference to the various operation steps shown in each FIGS. 2, 3, and 4 and in the steps of method 500 shown in FIG. 5A. FIGS. 2 and 3 provide additional details of some of the components of the system 100 shown in FIG. 1, so these additional details will be introduced before describing the methodologies shown in FIGS. 2, 3, and 4. As shown in FIG. 2, inside the Mocked libld.so 130, includes “mocked dlsym”, “mocked dlclose”, and “mocked dlopen”. The existing “libld.so” contains “dlsym( )”, “dlclose( )”, “dlopen( )”. By using the methodologies depicted in FIGS. 2-4, when the computer code 111 invokes “dlsym( )”, “dlclose( )”, “dlopen( )”, it actually invokes the “mocked dlsym”, “mocked dlclose”, and “mocked dlopen” in the mocked libld.so 130. The mocked libld.so 130 routes the function requests to the real libld.so inside the containerization platform 150 and 170.

Turning to FIG. 2, which depicts a system flow block diagram illustrating a system with a shared library correlation table, according to one embodiment. As shown in flow 200 of FIG. 2, when a computer code 111 invokes a dlopen function, such as open instruction 112, the DL interceptor module 120 intercepts the open instruction 112 at step 201 as a mocked dlopen 203 inside a mocked libdl.so shared library in the module 130. The session lifecycle management module 122 creates a session structure upon receiving the mocked dlopen 203. In some examples, the session lifecycle management module 122 creates a unique session structure for each respective computer code (e.g., computer code 111) upon receiving the mocked dlopen 203. The session structure contains, which contains a unique session ID, dynamic link library name and invokes various container operations such as Init( ) for initializing a container, destroy( ) for destroying a container, and invoke( ) for invoking the real functions inside the container.

In some examples, the container handling module 121 implements the container operations to initialize the containerization platforms 150 and 170, destroy the containerization platforms 150 and 170, and to deliver any dlsym( ) requests to the containerization platforms 150/170.

With reference to FIG. 3, illustrating system flow block diagram for a call function using the shared library correlation table, inside the containerization platform 150 is “libtarget_go.so”. The “libtarget_go.so” is an example name of a shared library. The examples described herein provide for unloading the shared library “libtarget_go.so” entirely without causing segmentation faults in the system.

Returning back to FIG. 2, for the dlopen, in a step when the end user invokes a dlopen function, it actually invokes a “mocked” dlopen inside libdl.so shared library. In a next step mocked dlopen talks to the session lifecycle management module 122. The session lifecycle management module 122 creates a session structure which contains a new UUID as the session ID; a new DL Name, the target shared library to be loaded; register container operations which is provided by the container handling module 121; and register parameter operations which are provided by the stack processing module 140. In a next step the mocked dlopen utilizes the init( ) method to create a new container.

In some examples, the mocked libld.so 130 intercepts the open instruction 112 and initiates the SLCT 250 in the mocked libdld.so 130 at step 202. For example, the module 130 generates, in a mock resource at an DL interceptor module 120, a shared library correlation table (SLCT), such as SLCT 250 which includes a reference count for a plurality of resources including at least an executable resource and at least one shared resource. For example, in the SLCT 250, Index [1] in index number column 251 refers to an executable resource: libtarget_go.so and Index[2] refers to a shared resource libssl.so. Each of the Index[1] and Index[2] include associated reference counts in reference count column 254. The SLCT 250 also includes running status or status column 252, containerized value column 253, dependent indexes column 255, and container ID column 256. In some examples, the mocked libld.so 130 also updates and alters the SLCT 250 upon receiving shared object information in executable information 260 and target information 265 as described in more detail in relation to FIG. 5.

With reference back to the dlsym shown in FIG. 3, in a step 310 of flow 300, when containerization platform 150 invokes a dlsym function, the stack processing module 140 sends the function to the DL interceptor module 120, at step 315, to invoke the mocked dlsym 210 and the mocked dlclose 220 inside the libdl.so shared library. The DL interceptor module 120 uses the SLCT 250 to determine the various called resources (including the invoked library and the shared/dependent libraries). In step 320, mocked dlsym is provided to the session lifecycle management module 122 and the session lifecycle management module 122 utilizes the pack( ) method which was registered by the stack processing module 140 in to convert the parameters from stack to protocol buffer 143. In step 325, the mocked dlsym utilizes the invoke( ) method as registered by the container handling module 121. As shown in FIG. 1, mocked dlsym retrieves the result and parameters, then utilizes the unpack( ) method to convert them from protocol buffer 143 to stack.

When the libraries are interdependent the mocked libld.so 130 receives a call package to the executable resource in the interceptor module, where the call package is provided to the interceptor module by a stack processing module. The mocked libld.so 130 determines, from dependent values, a number of dependent resources for the target resource, and compares a containerized value with the target resource to select a container identification from the SLCT for the target resource. The mocked libld.so 130 provides the call package, the container identification to a session management module for invocation of the call package.

In some examples, the init( ) method creates a container and uses the host image as the base image. The system directory, especially the library directory, is mapped on the host to the container, and the mapping stub module 151 is initialized. The mapping stub module 151 loads libld.so to an address space. In a next step the protocol buffer data is passed to the container, which includes session ID, target library name, and function name. Dlopen( ) is used in libld.so to load the target library to the address space. Dlopen( ) return a handler, and the handler will be used by dlsym( ) and dlclose( ). In a next step the session ID is mapped to the handler generated in last step. In a next step the destroy( ) method destroys the container, which was created.

In another example, the invoke( ) method passes the protocol buffer data to the mapping stub module 151, which includes session ID; function name; and function parameters. In a next step, the mapping stub module 151 gets the handler by the session ID. In a next step the mapping stub module 151 calls the target function by utilizing libld.so with the handler, the function name, and the function parameters. In a next step libld.so calls the real function.

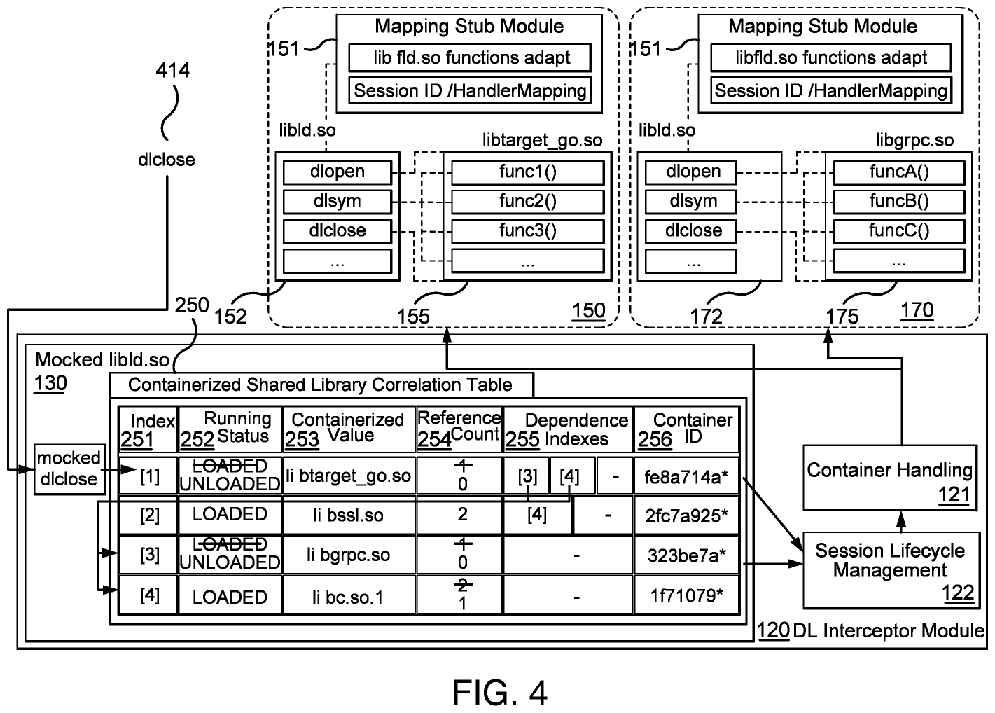

For dlclose in FIG. 4, in a next step when the end user invokes a dlclose function, the dlclose call actually invokes a mocked dlclose inside the libdl.so shared library. During a close function, the mocked libld.so 130 selects an entry in the SLCT 250, reduces a reference count of the selected entry in the SLCT, verifies a status of the selected entry based on the reference count, and causes an associated container of the selected entry to be removed from memory when the status of the selected entry indicates the associated container is not a shared resource. In some examples, the mocked dlclose invalidates the session ID in session structure and utilizes the destroy( ) method to destroy the container and free the session structure.

FIGS. 5A and 5B are respective methods 500 and 550 for a shared library correlation table. Method 500 begins at block 502 where the Mocked libld.so 130 receives an open function call for the executable resource in the interceptor module prior to generating the SLCT. For example, the mocked libld.so 130 receives the open instruction 112 as shown in FIG. 2.

At block 504, the Mocked libld.so 130 generates, in a mock resource at an interceptor module, a SLCT including a reference count for a plurality of resources. The resources include at least an executable resource and the at least one shared resource initiates, for each of the plurality of resources, a status in the SLCT at block 506. For example, with reference to FIG. 2, in response to receiving the open instruction 112, the Mocked libld.so 130 initiates the SLCT 250 which includes a reference count for a plurality of resources including at least an executable resource and at least one shared resource. In some examples, the SLCT 250 includes Index [1] in index number column 251 refers to an executable resource: libtarget_go.so and Index[2] refers to a shared resource libssl.so. Each of the Index[1] and Index[2] include associated reference counts in reference count column 254. The SLCT 250 also includes running status or status column 252, containerized value column 253, dependent indexes column 255, and container ID column 256. In some examples, the mocked libld.so 130 also updates and alters the SLCT 250 upon receiving shared object information in executable information 260 and target information 265.

At block 508, the Mocked libld.so 130 determines, from dependent value, a number of dependent resources for the target resource and determines a first set of dependent needed resources for an executable level of resources in the SLCT at block 510. At block 512 the Mocked libld.so 130 determines a second set of dependent needed resources based on the first set of dependent needed resources. For example, the Mocked libld.so 130 uses a DT_needed function to determine the various shared and interrelated resources for the libtarget_go.so and libssl.so. In some examples, the Mocked libld.so 130 continues determining dependent needed resources until all resources (including called and related resources) are identified in the SLCT 250.

At block 514, the Mocked libld.so 130 increases an associated reference count for each resource of the plurality of resources for each respective associated dependent needed resource. For example, the Mocked libld.so 130 increases associated counts in the column 254 based on a number of resources dependent on the Index[ ] row. At block 516, the Mocked libld.so 130 determines the status from the associated reference count in the SLCT. For example, in the SLCT 250, a respective resource of the plurality of resources is in a loaded state when the associated reference count in the column 254 is greater than 0, and the respective resource of the plurality of resources is in an unloaded state when an associated reference count is 0. In some examples, the status is noted in the in status column 252 of the SLCT 250.

At block 518, the Mocked libld.so 130 identifies a containerized value and containerized identification for each resource of the plurality of the plurality of resources. For example, the Mocked libld.so 130 identifies and populates the columns 252 and 256 with a nominal identification (e.g., value) in value column 253 and a container identification in the container ID column 256. When the various fields of SLCT 250 are populated, method 500 proceeds to block 520.

At block 520, the Mocked libld.so 130 determines whether a close function call has been received. In an example where a close function call has not been received, the Mocked libld.so 130 utilizes the SLCT during the execution of various process as described in relation to method 550 of FIG. 5B.

For example, at block 552 of method 550 in FIG. 5B, the Mocked libld.so 130 receives, from a stack processing module, a call function package to a target resource of the plurality of resources in the interceptor module. In some examples, as shown in FIG. 3, the call function may originate from containerization platforms 150 and 170 or via host 110. At block 554, the Mocked libld.so 130 determines, from a dependent value, a number of dependent resources for the target resource and compares a containerized value with the target resource to select a container identification from the SLCT for the target resource at block 556. At block 558, the Mocked libld.so 130 provides the call function package and the container identification to a session management module for invocation of the call function package.

Returning back to block 520 of FIG. 5A, when the Mocked libld.so 130 determines a close function call has been received, method 500 proceeds to block 522. For example, the Mocked libld.so 130 receives a close instruction 414 from either a container environment or the host 110 to close a given resource. At block 522, the Mocked libld.so 130 during a mocked close function, selects an entry in the SLCT, such as the SLCT 250, based on the close instruction 114 and reduces a reference count of the selected entry in the SLCT at block 524. For example, the Mocked libld.so 130 selects the Index[1] for closing and reduces the reference count in column 254 from 1 to 0. In some examples, the Mocked libld.so 130 then proceeds to the dependent indexes indicated in dependent indexes column 255 for closing.

At block 526, the Mocked libld.so 130 verifies a status of the selected entry based on the reference count and causes an associated container of the selected entry to be removed from memory when the status of the selected entry indicates the associated container is not a shared resource at block 528. For example, as shown in FIG. 4, the Index[1] indicates the libtarget_go.so has a reference count of “0” indicating an unloaded state and the session lifecycle management module 122 causes the container associated with the container ID in container ID column 256 to be removed from memory.

In some examples, when the current state of the selected entry indicates the selected entry is in a loaded state, such as the libc.so.1 resource in Index[4] of FIG. 4, the Mocked libld.so 130 causes the associated container of the selected entry to remain in the memory at block 527. In both examples, at block 528 and 527, the Mocked libld.so 130 returns to block 522 to select a next remaining entry in the SLCT 250 to unload until the SLCT 250 indicates all resources/Indexes[ ] associated with the close instruction 414 are unloaded. The use of the SLCT allows for shared resource unloading without causing associated segmentation in the shared resources and associated processes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

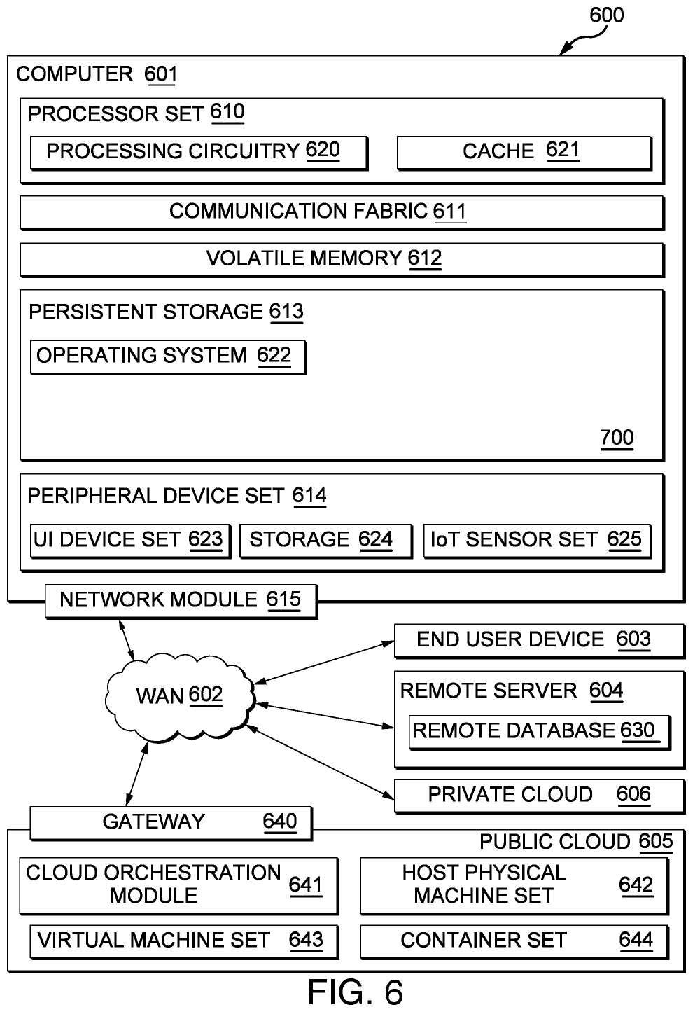

FIG. 6 depicts details of computing environment 600, according to one embodiment. Computing environment 600 contains an example of an environment for the execution of at least some of the computer code involved in performing the inventive methods, such as SLCT 250 and the DL interceptor module 120 in block 700. In addition to block 700, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 700, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 1. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 700 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 700 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

What is claimed is:

1. A method comprising:
generating, in a mock resource at an interceptor module, a shared library correlation table (SLCT) comprising a reference count for a plurality of resources that comprises at least one of an executable resource and a shared resource;
initiating, for each of the plurality of resources, a status in the SLCT;
during a close function, selecting an entry in the SLCT;
reducing a reference count of the selected entry in the SLCT;
verifying a status of the selected entry based on the reference count; and
causing an associated container of the selected entry to be removed from memory when the status of the selected entry indicates the associated container is not a shared resource.

2. The method of claim 1, wherein the SLCT further comprises an index number and dependent index numbers for each resource of the plurality of resources, wherein generating the SLCT comprises:
determining a number of associated dependent needed resources for the plurality of resources; and
increasing an associated reference count for each resource of the plurality of resources for each respective associated dependent needed resource.

3. The method of claim 2, wherein the SLCT further comprises a containerized value, a dependent value, and a container identification for each resource in the SLCT, wherein initiating the status for each of the plurality of resources in the SLCT further comprises:
determining the status from the associated reference count, wherein a respective resource of the plurality of resources is in a loaded state when an associated reference count is above 0, and wherein a respective resource of the plurality of resources is in an unloaded state when an associated reference count is 0; and
determining a containerized value and containerized identification for each resource of the plurality of the plurality of resources.

4. The method of claim 3, further comprising:
receiving a call package to the executable resource in the interceptor module, wherein the call package is provided to the interceptor module by a stack processing module;
determining, from dependent value, a number of dependent resources for a target resource;
comparing a containerized value with the target resource to select a container identification from the SLCT for the target resource; and
providing the call package, the container identification to a session management module for invocation of the call package.

5. The method of claim 1, further comprising:
receiving an open function call for a target resource in the interceptor module, wherein the open function call is provided to the interceptor module by a stack processing module.

6. The method of claim 5, wherein the interceptor module is in communication with a mapping stub module communicatively coupled to the stack processing module.

7. The method of claim 6, wherein: the mock resource is stored on the interceptor module.

8. A system comprising a memory communicatively coupled to a processor, wherein the processor is configured to perform an operation comprising:
generating, in a mock resource at an interceptor module, a shared library correlation table (SLCT) comprising a reference count for a plurality of resources that comprises at least an executable resource and at least one shared resource;
initiating, for each of the plurality of resources, a status in the SLCT;
during a close function, selecting an entry in the SLCT;
reducing a reference count of the selected entry in the SLCT;
verifying a status of the selected entry based on the reference count; and
causing an associated container of the selected entry to be removed from memory when the status of the selected entry indicates the associated container is not a shared resource.

9. The system of claim 8, wherein the SLCT further comprises an index number and dependent index numbers for each resource of the plurality of resources, wherein generating the SLCT comprises:
determining a number of associated dependent needed resources for the plurality of resources; and
increasing an associated reference count for each resource of the plurality of resources for each respective associated dependent needed resource.

10. The system of claim 9, wherein the SLCT further comprises a containerized value, a dependent value, and a container identification for each resource in the SLCT, wherein initiating the status for each of the plurality of resources in the SLCT further comprises:
determining the status from the associated reference count, wherein a respective resource of the plurality of resources is in a loaded state when an associated reference count is above 0, and wherein a respective resource of the plurality of resources is in a unloaded state when an associated reference count is 0; and
determining a containerized value and containerized identification for each resource of the plurality of the plurality of resources.

11. The system of claim 10, wherein the operation further comprises:
receiving a call package to the executable resource in the interceptor module, wherein the call package is provided to the interceptor module by a stack processing module;
determining, from dependent value, a number of dependent resources for a target resource;
comparing a containerized value with a target resource to select a container identification from the SLCT for the target resource; and
providing the call package, the container identification to a session management module for invocation of the call package.

12. The system of claim 8, wherein the operation further comprises:
receiving an open function call for a target resource in the interceptor module, wherein the open function call is provided to the interceptor module by a stack processing module.

13. The system of claim 12, wherein the interceptor module is in communication with a mapping stub module communicatively coupled to the stack processing module.

14. The system of claim 13, wherein
the mock resource is stored on the interceptor module.

15. A computer program product comprising a computer readable program stored on a computer readable storage medium, wherein the computer readable program, when executed on a processor, causes the processor to perform an operation comprising:
generating, in a mock resource at an interceptor module, a shared library correlation table (SLCT) comprising a reference count for a plurality of resources that comprises at least an executable resource and at least one shared resource;
initiating, for each of the plurality of resources, a status in the SLCT;
during a close function, selecting an entry in the SLCT;
reducing a reference count of the selected entry in the SLCT;
verifying a status of the selected entry based on the reference count; and
causing an associated container of the selected entry to be removed from memory when the status of the selected entry indicates the associated container is not a shared resource.

16. The computer program product of claim 15, wherein the SLCT further comprises an index number and dependent index numbers for each resource of the plurality of resources, wherein generating the SLCT comprises:
determining a number of associated dependent needed resources for the plurality of resources; and
increasing an associated reference count for each resource of the plurality of resources for each respective associated dependent needed resource.

17. The computer program product of claim 16, wherein the SLCT further comprises a containerized value, a dependent value, and a container identification for each resource in the SLCT, wherein initiating the status for each of the plurality of resources in the SLCT further comprises:
determining the status from the associated reference count, wherein a respective resource of the plurality of resources is in a loaded state when an associated reference count is above 0, and wherein a respective resource of the plurality of resources is in a unloaded state when an associated reference count is 0; and
determining a containerized value and containerized identification for each resource of the plurality of the plurality of resources.

18. The computer program product of claim 17, wherein the operation further comprises:
receiving a call package to the executable resource in the interceptor module, wherein the call package is provided to the interceptor module by a stack processing module;
determining, from dependent value, a number of dependent resources for a target resource;
comparing a containerized value with the target resource to select a container identification from the SLCT for the target resource; and
providing the call package, the container identification to a session management module for invocation of the call package.

19. The computer program product of claim 15, wherein the operation further comprises:
receiving an open function call for a target resource in the interceptor module, wherein the open function call is provided to the interceptor module by a stack processing module.

20. The computer program product of claim 19, wherein the interceptor module is in communication with a mapping stub module communicatively coupled to the stack processing module, and
the mock resource is stored on the interceptor module.
